(19) United States
(12) Patent Application Publication
(10) Pub. No.: US 2011/0243288 A1
(43) Pub. Date: Oct. 6, 2011

(54) COOPERATIVE APPARATUS AND FREQUENCY SYNCHRONIZATION METHOD THEREOF FOR USE IN WIRELESS NETWORK

(75) Inventors: Shau-Yu CHENG, Hsinchu County (TW); You-Hsien LIN, Taipei City (TW); Terng-Yin HSU, Hsinchu County (TW); Yi-Ting LIN, New Taipei City (TW)

(73) Assignee: INSTITUTE FOR INFORMATION INDUSTRY, Taipei (TW)

(21) Appl. No.: 13/078,556

(22) Filed: Apr. 1, 2011

Related U.S. Application Data
(60) Provisional application No. 61/320,333, filed on Apr. 2, 2010.

(51) Int. Cl. H04L 7/04

(52) U.S. Cl. 375/362

(57) ABSTRACT

A cooperative apparatus and a frequency synchronization method thereof for use in a wireless network are provided. The wireless network comprises a base station and a subscriber station. The cooperative apparatus retrieves a signal from the base station and calculates a frequency offset between the base station and the cooperative apparatus according to the signal. Accordingly, the cooperative receives a cooperative information from the base station and forwards the cooperative information to the subscriber station based on the frequency offset.

### PRIORITY

This application claims the benefit of U.S. Provisional Application Ser. No. 61/320,333 filed on Apr. 2, 2010, which is hereby incorporated by reference herein in its entirety.

### FIELD

The present invention relates to a cooperative apparatus and a frequency synchronization method thereof. More particularly, the cooperative apparatus and the frequency synchronization method thereof of the present invention are capable of synchronizing frequency by frequency pre-compensation.

### BACKGROUND

In wireless networks, higher data transmission rate means the demand of higher signal to noise ratio (SNR). Accordingly, in order to provide higher SNR, relay nodes and cooperative transmission techniques are therefore introduced. In some wireless networks with relay nodes, the allocations of cell identifications and pilot signals (ex., common reference signal, CRS) are omitted for reducing the network costs. Hence, the transmissions and accesses between the apparatus in the wireless networks with relay nodes can be achieved more efficiently.

However, when the allocations of cell identifications and pilot signals are omitted for efficient reasons, the synchronization problems between the apparatus may be occurred. Particularly, in the protocols of the wireless networks without any mechanism for coordinating purpose, when a base station requests a relay node to transmit information to a subscriber station cooperatively, the mobile station may decode the information incorrectly since the subscriber station can not precisely estimate the difference of frequency between the base station and the relay node.

In other words, because the frequencies of the oscillators of the base station, the relay node and the subscriber station are not exactly the same, differences of frequencies between the base station, relay node and subscriber station exist. Therefore, under a cooperation mode, the mobile station can not correctly receive the information from the base station and the relay node together since the frequencies of the base station and the relay node are different and the subscriber station is not capable of estimating the difference of frequency between the base station and the relay node.

Accordingly, an urgent need exists in the wireless networks to keep the lower cost and correct data transmission.

### SUMMARY

To address the aforesaid issues, an objective of certain embodiments of the present invention is to provide a frequency synchronization method for a cooperative apparatus. The cooperative apparatus is used in a wireless network. The wireless network comprises a base station and a subscriber station. The frequency synchronization method comprises the following steps of: (a) enabling the cooperative apparatus to retrieve a signal from the base station; (b) enabling the cooperative apparatus to calculate a frequency offset between the base station and the cooperative apparatus according to the signal; (c) enabling the cooperative apparatus to receive an cooperative information from the base station; and (d) enabling the cooperative apparatus to forward the cooperative information to the subscriber station based on the frequency offset.

Another objective of certain embodiments of the invention is to provide a cooperative apparatus for use in a wireless network. The wireless network comprises a base station and a subscriber station. The cooperative apparatus comprises a transceiver and a processing unit. The transceiver is configured to retrieve a signal the base station to the subscriber station. The processing unit is configured to calculate a frequency offset between the base station and the cooperative apparatus according to the signal. The transceiver is further configured to receive a cooperative information from the base station and to forward the cooperative information to the subscriber station based on the frequency offset.

With the technical features disclosed above, the cooperative apparatus and the frequency synchronization method of certain embodiments of the present invention can achieve a pre-compensation of frequency offset which is caused of different frequencies between the cooperative apparatus and the base station. Accordingly, under a cooperation mode, the cooperative apparatus can transmit the information to the subscriber station with the base station cooperatively and correctly since the frequency offset between the base station and the cooperative apparatus has been compensated.

The detailed technology and preferred embodiments implemented for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1A is a schematic view of a wireless network of a first example embodiment of the present invention;

FIG. 1B is a schematic view of a cooperative apparatus of the first example embodiment of the present invention; and

FIG. 2 is a flowchart of a frequency synchronization method of a second example embodiment of the present invention.

### DETAILED DESCRIPTION

In the following descriptions, the present invention will be explained with reference to example embodiments thereof. However, these example embodiments are not intended to limit the present invention to any specific example, embodiment, environment, applications or particular implementations described in these example embodiments. Therefore, description of these example embodiments is only for purpose of illustration rather than to limit the present invention. It should be appreciated that, in the following example embodiments and the attached drawings, elements not directly related to the present invention are omitted from depiction.

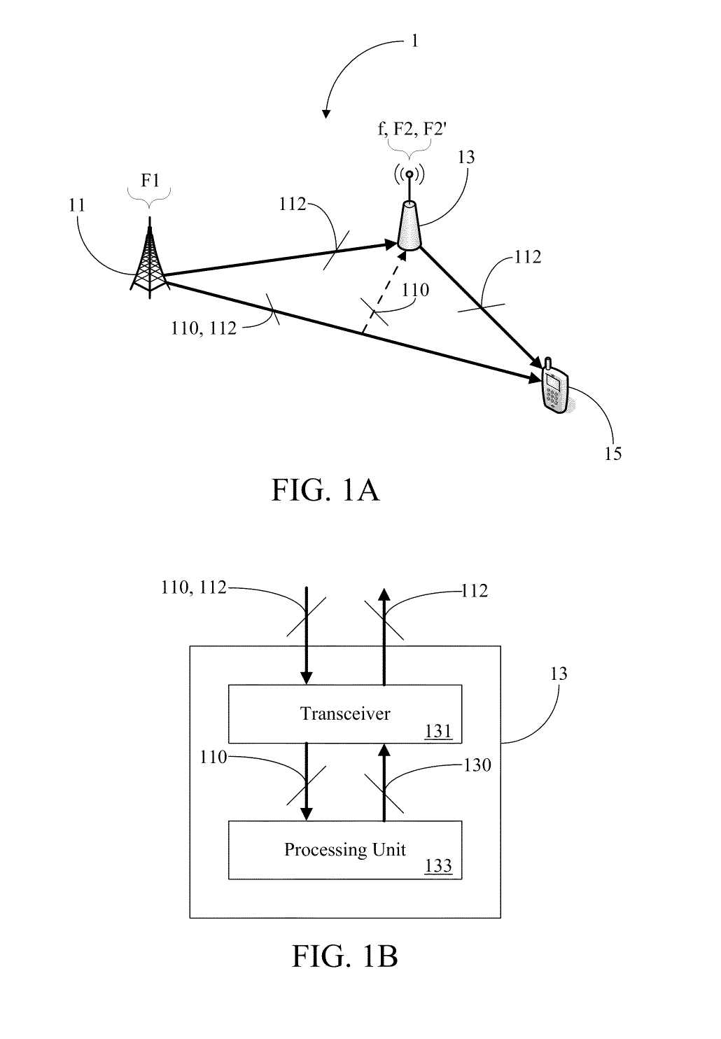

Please refer to FIGS. 1A and 1B first. FIG. 1A illustrates a wireless network 1 of a first embodiment of the present invention. The wireless network 1 comprises a base station 11, a cooperative apparatus 13 and a subscriber station 15. It should be noted that the cooperative apparatus 13 is a relay node in the first embodiment. However, it is not to limit the implementation of the cooperative apparatus 13. In other embodiments, the cooperative apparatus 13 can be another base station or any apparatus which can achieve the cooperative transmission with the base station 11. FIG. 1B illustrates schematic views of the cooperative apparatus 13 of the first embodiment. The cooperative apparatus 13 comprises a transceiver 131 and a processing unit 133. The interactions between the base station 11, the cooperative apparatus 13 and the subscriber station 15 will be further described hereinafter.

First, the cooperative apparatus 13 needs to obtain some information for compensating the difference of the frequency between the base station 11 and the cooperative apparatus 13. Particularly, when the base station 11 transmits a signal 110 to the cooperative apparatus 13 or to the subscriber station 15 in broadcast channel, the cooperative apparatus 13 is capable of retrieving the signal 110 by the transceiver 131. After retrieving the signal 110, the processing unit 133 of the cooperative 13 calculates a frequency offset 130 between the base station 11 and the cooperative apparatus 13 according to the signal 110.

More specifically, the signal 110 transmitted from the base station 11 comprises data with an oscillator central frequency F1 of the base station 11. Hence, the processing unit 133 of the cooperative apparatus 13 can obtain the oscillator central frequency F1 of the base station 11 from the signal 110, and then calculates the frequency offset 130 between the base station 11 and the cooperative apparatus 13 based on the oscillator central frequency F1 of the base station 11 and an oscillator central frequency F2 of the cooperative apparatus 13.

It should be noted that the oscillator central frequency F1 of the base station 11 indicates the central frequency of an oscillator of the base station 11, the oscillator central frequency F2 of the cooperative apparatus 13 obviously indicates the central frequency of an oscillator of the cooperative apparatus 13, and the frequency offset 130 indicates the offset between the frequency F1 and the oscillator central frequency F2.

After calculating the frequency offset 130, the cooperative apparatus 13 can transmit information to the subscriber station 15 cooperatively and correctly with the base station 11. Specifically, when the base station 11 requests the cooperative apparatus 13 to transmit a cooperative information 112 to the subscriber station 15 cooperatively, the transceiver 131 of the cooperative apparatus 13 firstly receives the cooperative information 112 from the base station 11. Then the transceiver 131 of the cooperative apparatus 13 forwards the cooperative information 112 to the subscriber station 15 based on the frequency offset 130.

More specifically, before the transceiver 131 of the cooperative apparatus 13 forwards the cooperative information 112, two frequency compensating implementations can be applied. First one, the processing unit 133 of the cooperative apparatus 13 calculates a compensated frequency F2′ by shifting the oscillator central frequency F2 of the cooperative apparatus 13 with the frequency offset 130. Then, the transceiver 131 of the cooperative apparatus 13 forwards the cooperative information 112 to the subscriber station 15 as the compensated frequency F2′.

In other words, the cooperative apparatus 13 first shifts the oscillator central frequency F2 with the frequency offset 130 so that the cooperative apparatus 13 can forward the cooperative information 112 to the subscriber station 15 as the result of the shifting of frequency offset 130 and the oscillator central frequency F2, i.e., the compensated frequency F2′. Therefore, the subscriber station 15 can receive and decode the cooperative information 112 from both the base station 11 and the cooperative apparatus 13 correctly since the difference of the frequency between the base station 11 and the cooperative apparatus 13 has been compensated.

On the other hand, the second implementation of frequency compensation, the processing unit 133 of the cooperative apparatus 13 calculates a compensated frequency F2′ by multiplying the frequency offset 130 by a transmission frequency f of the cooperative information 112. It should be noted that the transmission frequency f of the cooperative information 112 is decided by the cooperative apparatus 13 and then used as a frequency for transmitting the cooperative information 112.

Then, the transceiver 131 of the cooperative apparatus 13 forwards the cooperative information 112 to the subscriber station 15 as the compensated frequency F2′. In other words, the cooperative apparatus 13 compensates the transmission frequency f of the cooperative information 112 before the cooperative information 112 is directly transmitted to the subscriber station 15 as the oscillator central frequency F2 of the cooperative apparatus 13. Therefore, the subscriber station 15 can receive and decode the cooperative information 112 from both the base station 11 and the cooperative apparatus 13 correctly since the difference of the frequency between the base station 11 and the cooperative apparatus 13 has been compensated.

It should be appreciated that the wireless network 1 of the first embodiment conforms to any kind of wireless networks standards. For example, the base station 11 is an evolved nodeB (eNB) and the subscriber station 15 is an use equipment (UE) when the wireless network 1 is a Long Term Evolution (LTE) network. However, it is not to limit the environment of the wireless network of the present invention.

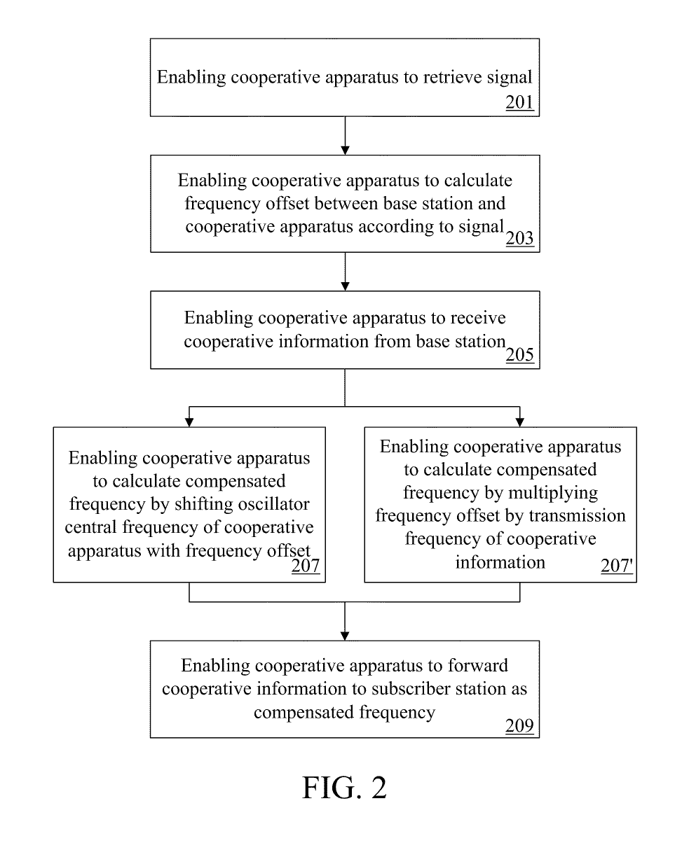

A second embodiment of the present invention is a frequency synchronization method, a flowchart of which is shown in FIG. 2. The frequency synchronization method of the second embodiment is adapted for a cooperative apparatus, e.g., the cooperative apparatus 13 described in the first embodiment. The cooperative apparatus is used in a wireless network. The wireless network comprises a base station and a subscriber station. Detailed steps of the second embodiment will be described as follows.

First, the cooperative apparatus needs to obtain some information for compensating the difference of the frequency between the base station and the cooperative apparatus. Hence, step 201 is executed to enable the cooperative apparatus to retrieve a signal from the base station. Specifically, because the base station transmits the signal to the cooperative apparatus or to the subscriber station in broadcast channel; hence, the cooperative apparatus is capable of retrieving the signal.

After retrieving the signal, step 203 is executed to enable the cooperative to calculate a frequency offset between the base station and the cooperative apparatus according to the signal. It should be noted that, the signal transmitted from the base station comprises data with a oscillator central frequency of the base station. Hence, the cooperative apparatus can measure the frequency of the base station from the signal, and then calculates the frequency offset between the base station and the cooperative apparatus based on the oscillator central frequency of the base station and an oscillator central frequency of the cooperative apparatus.

Similarly, the oscillator central frequency of the base station indicates the central frequency of an oscillator of the base station, the oscillator central frequency of the cooperative apparatus obviously indicates the central frequency of an oscillator of the cooperative apparatus, and the frequency offset indicates the offset between the frequency of the base station and the oscillator central frequency of the cooperative apparatus.

Afterwards, the cooperative apparatus can transmit information to the subscriber station cooperatively and correctly with the base station. Step 205 is executed to enable the cooperative apparatus to receive a cooperative information from the base station after the base station requests the cooperative apparatus to transmit the cooperative information to the subscriber station cooperatively. Then, the cooperative apparatus forwards the cooperative information to the subscriber station based on the frequency offset.

Specifically, before the cooperative apparatus forwards the cooperative information, two frequency synchronization steps can be proceed. First choice, step 207 is executed to enable the cooperative apparatus to calculate a compensated frequency by shifting the oscillator central frequency of the cooperative apparatus with the frequency offset. Next, step 209 is executed to enable the cooperative apparatus to forward the cooperative information to the subscriber station as the compensated frequency.

In other words, the cooperative apparatus shifts the oscillator central frequency of the cooperative apparatus with the frequency offset so that the cooperative apparatus can forward the cooperative information to the subscriber station as the result of the shifting of frequency offset and the oscillator central frequency of the cooperative apparatus, i.e., the compensated frequency. Therefore, the subscriber station can receive and decode the cooperative information from both the base station and the cooperative apparatus with correct frequencies since the difference of the frequency between the base station and the cooperative apparatus has been compensated.

On the other hand, the second choice, step 207′ is executed to enable the cooperative apparatus to calculate a compensated frequency by multiplying the frequency offset by a transmission frequency of the cooperative information. It should be noted that the transmission frequency of the cooperative information is decided by the cooperative apparatus and then used as a frequency for transmitting the cooperative information.

Likewise, step 209 is then executed to enable the cooperative apparatus to forward the cooperative information to the subscriber station as the compensated frequency. In other words, the cooperative apparatus compensates the transmission frequency of the cooperative information before the cooperative information is directly transmitted to the subscriber station as the oscillator central frequency of the cooperative apparatus. Therefore, the subscriber station can receive and decode the cooperative information from both the base station and the cooperative apparatus correctly since the difference of the frequency between the base station and the cooperative apparatus has been compensated.

Similarly the wireless network of the second embodiment conforms to any kind of wireless networks standards. For example, the base station is an eNB and the subscriber station is an use equipment when the wireless network is an LTE network. However, it is not to limit the environment of the wireless network of the present invention.

According to the above descriptions, the cooperative apparatus and the frequency synchronization method of the present invention can transmit information to the subscriber station with the base station cooperatively and correctly by pre-compensating the difference of the frequency between the base station and the cooperative apparatus. Thereby, based on the present invention, the cost of wireless networks can be reduced, and the cooperative data can be transmitted correctly.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A frequency synchronization method for a cooperative apparatus, the cooperative apparatus being used in a wireless network, the wireless network comprising a base station and a subscriber station, the frequency synchronization method comprising the steps of:
(a) enabling the cooperative apparatus to retrieve a signal from the base station;
(b) enabling the cooperative apparatus to calculate a frequency offset between the base station and the cooperative apparatus according to the signal;
(c) enabling the cooperative apparatus to receive a cooperative information from the base station;
(d) enabling the cooperative apparatus to forward the cooperative information to the subscriber station based on the frequency offset.

2. The frequency synchronization method as claimed in claim 1, wherein the signal further comprises data with an oscillator central frequency of the base station, and the step (b) further comprises the step of:
(b1) enabling the cooperative apparatus to calculate the frequency offset between the base station and the cooperative apparatus based on the oscillator central frequency of the base station and an oscillator central frequency of the cooperative apparatus.

3. The frequency synchronization method as claimed in claim 2, wherein the step (d) further comprises the steps of:
(d1) enabling the cooperative apparatus to calculate a compensated frequency by shifting the oscillator central frequency of the cooperative apparatus with the frequency offset;
(d2) enabling the cooperative apparatus to forward the cooperative information to the subscriber station as the compensated frequency.

4. The frequency synchronization method as claimed in claim 2, wherein the step (d) further comprises the steps of:
(d1) enabling the cooperative apparatus to calculate a compensated frequency by multiplying the frequency offset by a transmission frequency of the cooperative information;
(d2) enabling the cooperative apparatus to forward the cooperative information to the subscriber station as the compensated frequency.

5. The frequency synchronization method as claimed in claim 1, wherein the wireless network conforms to Long Term Evolution (LTE) standard, the base station is an evolved nodeB (eNB), and the subscriber station is a use equipment (UE).

6. A cooperative apparatus for use in wireless network, the wireless network comprising a base station and a subscriber station, the cooperative apparatus comprising:
a transceiver; and
a processing unit;
wherein the transceiver is configured to retrieve a signal from the base station, the processing unit is configured to calculate a frequency offset between the base station and the cooperative apparatus according to the signal, and the transceiver is further configured to receive a cooperative information from the base station and to forward the cooperative information to the user equipment based on the frequency offset.

7. The cooperative apparatus as claimed in claim 6, wherein the signal further comprises data with an oscillator central frequency of the base station, and processing unit is further configured to calculates the frequency offset between the base station and the cooperative apparatus based on the oscillator central frequency of the base station and an oscillator central frequency of the cooperative apparatus.

8. The cooperative apparatus as claimed in claim 7, wherein the processing unit is further configured to calculate a compensated frequency by shifting the oscillator central frequency of the cooperative apparatus with the frequency offset, and the transceiver is further configured to forward the cooperative information to the subscriber station as the compensated frequency.

9. The cooperative apparatus as claimed in claim 7, wherein the processing unit is further configured to calculate a compensated frequency by multiplying the frequency offset by a transmission frequency of the cooperative information, and the transceiver is further configured to forward the cooperative information to the subscriber station as the compensated frequency.

10. The cooperative apparatus as claimed in claim 6, wherein the wireless network conforms to Long Term Evolution (LTE) standard, the base station is an evolved nodeB (eNB), and the subscriber station is a use equipment (UE).
